(19) United States
(12) Patent Application Publication
(10) Pub. No.: US 2009/0081503 A1
(43) Pub. Date: Mar. 26, 2009

(54) FUEL CELL SYSTEM AND DRIVING METHOD THEREOF

(76) Inventors: Ri-a Ju, Suwon-si (KR); Jin-hong An, Suwon-si (KR); Woong-ho Cho, Suwon-si (KR); Ho-jin Kweon, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/149,943

(22) Filed: May 9, 2008

(30) Foreign Application Priority Data
Sep. 21, 2007 (KR) 10-2007-0096760

(51) Int. Cl. H01M 8/04

(52) U.S. Cl. 429/22; 429/34; 429/14

(57) ABSTRACT

A fuel cell system capable of exactly controlling a concentration of a fuel supplied for generation of electricity regardless of deterioration of a concentration sensor with time, and a driving method thereof include: a fuel cell stack to generate electric power through an electrochemical reaction of hydrogen and oxygen; a mixing tank to supply a diluted fuel to the fuel cell stack, the diluted fuel obtained by mixing a raw fuel with water discharged from the fuel cell stack; a reference concentration tank to store a predetermined optimum concentration of a reference solution for the fuel cell stack; and a concentration sensing module to measure a concentration of either the diluted fuel or the reference solution.

### CLAIM OF PRIORITY

This application makes reference to, incorporates the same herein, and claims all benefits accruing under 35 U.S.C. §119 from an application for FUEL CELL SYSTEM AND DRIVING METHOD OF IT earlier filed in the Korean Intellectual Property Office on the 21^{st} of September 2007 and there duly assigned Serial No. 10-2007-0096760.

### BACKGROUND OF THE INVENTION

1. Field of the Invention

The present invention relates to a fuel cell system using a fluid state of fuel, and more particularly, the present invention relates to a fuel cell system capable of exactly measuring a concentration of a fuel supplied for generation of electricity regardless of deterioration of a concentration sensor with time, and a driving method thereof.

2. Description of Related Art

A fuel cell is a generator system for generating electricity through the well-balanced electrochemical reaction of oxygen in the air with hydrogen included in hydrocarbon-based materials, such as methanol, ethanol and natural gas.

Fuel cells are divided into phosphoric acid fuel cells, molten carbonate fuel cells, solid oxide fuel cells, polymer electrolyte membrane fuel cells, alkaline fuel cells and the like according to the electrolytes used. Each of the fuel cells basically operates on the same principle, but is different in the fuels used, the operating temperature, the catalysts, the electrolytes, etc.

Among them, a Polymer Electrolyte Membrane Fuel Cell (PEMFC) has excellent output characteristics, a low operating temperature and rapid driving and response time, compared to the other fuel cells, and is widely used in the fields of distributed power sources such as in static power plants of housing and public buildings, as well as transportable power sources, such as in portable electronic equipment and movable power sources, such as automobile power sources.

There is also a Direct Methanol Fuel Cell (DMFC), which is similar to the PEMFC but may directly supply liquid methanol fuel to a stack. The DMFC is more advantageous since it does not use a reformer to obtain hydrogen from a fuel unlike the polymer PEMFC.

The above-mentioned DMFC, for example, includes a stack, a fuel tank and a fuel pump. The stack generates an electrical energy by allowing an oxidant, such as oxygen or air, to react with a hydrogen-containing fuel. This stack generally has a structure in which several to several tens of single fuel cells are stacked, each of the single fuel cells being composed of a Membrane Electrode Assembly (MEA) and a separator. The membrane electrode assembly has a structure where an anode electrode (referred to as a “fuel polarity” or an “oxidation electrode”) and a cathode electrode (referred to as a “cathode polarity” or a “reduction electrode”) are attached to both sides of a polymer electrolyte membrane.

For the DMFC in which a fuel is supplied is a fluid state to a stack, its operating efficiency is greatly varies according to the molar concentration of a fuel supplied to the anode electrode and the cathode electrode. For example, when a molar concentration of a fuel supplied to the anode electrode is relatively high, an amount of the fuel transmitted from an anode to a cathode is increased due to the limitations of the polymer electrolyte membranes that may be used recently, and therefore a back electromotive force is caused due to the reaction of the fuel in the cathode electrode, which leads to the reduced output. This is why the fuel cell stack shows the optimum operating efficiency in a predetermined fuel concentration, depending on the configuration and characteristics of the fuel cell stack. Accordingly, there have been required plans of suitably adjusting a molar concentration of a fuel for stable operations in the direct methanol fuel cell.

For this purpose, the conventional DMFC may include a measuring unit for measuring a concentration a solution stored in facilities, such as a stack, a fuel tank or a recycle tank, or a solution flowing through pipes installed between the facilities.

For the conventional DMFC provided with the concentration measuring unit, a driving state of the fuel cell system may be estimated by measuring a concentration of an aqueous fuel solution, etc., and the driving efficiency of the fuel cell may be improved by controlling components constituting the fuel cell system, depending on the estimation results.

However, concentration sensors that have been widely used are changed in the concentration sensing strength with time, and therefore there is a deviation between a sensing value in the initial use of the fuel cell system and a sensing value after the use of the fuel cell system for some period.

Accordingly, there is a need for a unit that may compensate for the deviation for the exact sensing and drive controlling of a diluted fuel.

### SUMMARY OF THE INVENTION

Accordingly, the present invention is designed to solve such drawbacks of the prior art, and therefore, an object of the present invention is to provide a fuel cell system to compensate for a deviation of a concentration sensor that occurs with time.

One embodiment of the present invention is achieved by providing a fuel cell system including: a fuel cell stack to generate electric power through an electrochemical reaction of hydrogen and oxygen; a mixing tank to generate a diluted fuel by mixing a raw fuel with water discharged from the fuel cell stack; a reference concentration tank to store a predetermined optimum concentration of a reference solution for the fuel cell stack; and a concentration sensing module to measure a concentration of either the diluted fuel or the reference solution.

The concentration sensing module may further include a concentration comparator/controller to compare the results obtained by measuring concentrations of the diluted fuel and the reference solution, and to control influx quantity of fluids flowing in the mixing tank.

The concentration sensing module may include: a sensing chamber having a concentration sensor arranged within; a reference solution inlet to enable inflow of the reference solution into the sensing chamber; a fuel inlet to enable inflow of the diluted fuel into the sensing chamber; a first regulating unit arranged within the fuel inlet; and a second regulating unit arranged within the reference solution inlet. The sensing chamber represents a region where a solution sensed by the installed concentration sensor is located, and is therefore represented by a chamber, but may also be formed without any of clear physical demarcation, for example, becoming some region of a pipe.

A method of driving a fuel cell system having the above-mentioned configuration: uses a concentration sensor to maintain a constant concentration of a diluted fuel, supplied to a fuel cell stack, to a predetermined reference concentration, operates the fuel cell system in a normal mode while counting the accumulated use time; operates the fuel cell system in a concentration sensing mode to calculate a compensation value of a concentration sensor when the counted accumulated use time is equal to a reference time; and applies the compensation value to a concentration sensing value of the concentration sensor, followed by repeating operating the fuel cell system in a normal mode while counting the accumulated use time.

### BRIEF DESCRIPTION OF THE DRAWINGS

These and/or other embodiments and features of the present invention will become apparent and more readily appreciated from the following description of certain exemplary embodiments, taken in conjunction with the accompanying drawings of which:

FIG. 1 is a block diagram of a DMFC system.

FIG. 2 is a block diagram of a DMFC system according to one exemplary embodiment of the present invention.

FIGS. 3A and 3B are structural diagrams of specific embodiments of the concentration sensing module of FIG. 2.

FIG. 4 is a flowchart of a method of driving a fuel cell system in which the concentration comparator/controller of FIG. 2 is operated.

### DETAILED DESCRIPTION OF THE INVENTION

Hereinafter, certain exemplary embodiments according to the present invention are described with reference to the accompanying drawings. When a first element is described as being coupled to a second element, the first element may be not only directly coupled to the second element but may also be indirectly coupled to the second element via a third element. Furthermore, elements that are not essential to the complete understanding of the present invention have been omitted for clarity. Also, like reference numerals refer to like elements throughout.

For example, the term fuel cell stack is used in the description of the present invention, but is merely used for convenience, and the fuel cell stack used in the description of the present invention includes a stack composed of laminated unit cells, a stack composed of flat unit cells, and a single stack including a single unit cell.

Also, a DMFC system is described in detail in exemplary embodiments of the present invention, but it is evident that a fuel cell system (e.g., a fuel cell system using an aqueous acetic acid solution as a fuel) having a mixing tank for recycling an unreacted fuel may be applicable to the spirit of the present invention, and this is also included with the spirit and scope of the present invention.

In the detailed description, the term ‘high concentration fuel’ may mean a high concentration fuel selected from the group consisting of hydrocarbon-based fuels composed of ethanol, methanol and natural gas.

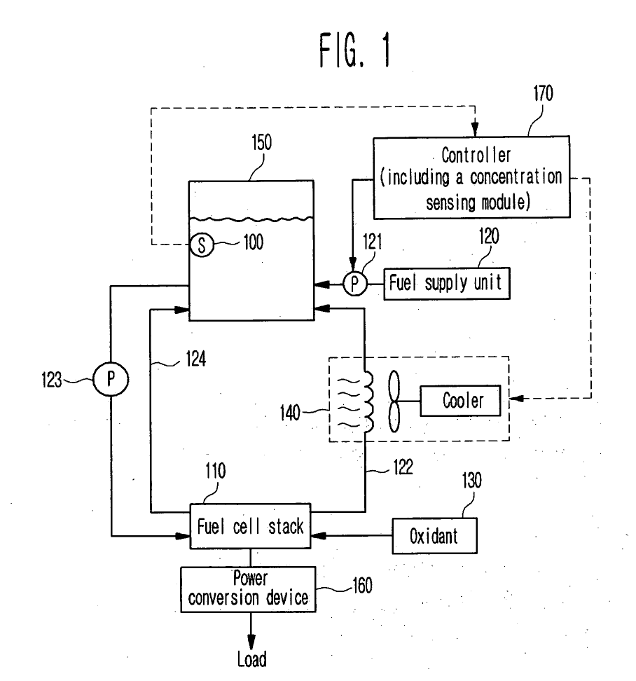

FIG. 1 is a block diagram of a DMFC system. Referring to FIG. 1, the fuel cell system includes a stack 110 for generating electricity through a chemical reaction of hydrogen and oxygen; a fuel supply unit 120 for storing a high concentration fuel to be supplied to the stack 110; an oxidant supply unit 130 for supplying an oxidant to the stack 110; a heat exchanger 140 for recovering unreacted fuel and water discharged from the stack 110; and a mixing device 150 for supplying a hydrogen-containing fuel to the stack 110, the hydrogen-containing fuel being prepared by mixing the high concentration fuel, supplied from the fuel storing unit 120, with the unreacted fuel and water discharged from the heat exchanger 140. The heat exchanger 140 and the mixing device 150 may have a function to treat unnecessary fluids such as carbon dioxide and the like discharged from the stack 110. The fuel storing unit 120, the mixing device 150 and a pump 121 function to supply fuel.

The electrical energy generated through the chemical reaction of hydrogen gas and oxygen in the unit cell is outputted as an external load after its current/voltage are converted through a power conversion device 160 to meet a power standard. According to the exemplary embodiments, the output of the power conversion device 160 may have a configuration to charge a separately provided secondary battery, and a configuration to supply a power source for a controller 170.

Effluents, which are discharged from the stack 110 and mixed with carbon dioxide (CO₂), vapor (H₂0) and unreacted fuels, move to a condensing unit of the heat exchanger 140, and an unreacted fuel and water condensed in the heat exchanger 140 is collected into the mixing device 150. The carbon dioxide may be discharged out from the mixing device 150. The unreacted fuel and water collected in the mixing device 150 are mixed with the high concentration fuel supplied from the fuel storing unit 120, and then supplied to an anode of the stack 110.

The oxidant supply unit 130 includes an air supply unit for supplying air as an oxidant. The oxidant supply unit 130 may be an active driving pump for supplying the air to a cathode of the stack 110, or may be a passive air vent hole having a structure to merely facilitate the flow of the air.

The controller 170 controls a driving pump 121 for the fuel storing unit 120, and a pump 123 for supplying a diluted fuel to the stack 110. The controller 170 controls a pump installed inside pipes 122 and 124 between the stack 110 and the mixing device 150, or a pump installed inside the oxidant supply unit 130, as well as the above-mentioned pumps 121 and 123. The controller 170 may be either a hardware module and/or a software module including a digital processor.

Input data that the controller 170 requires to control the pumps may be a concentration value, a temperature value of the measured fuel cell, or an electric current, a voltage of a power conversion device, etc.

The controller 170 increases the supply of fuels to the stack 110 by operating the pump 123 to enhance electric generator capacity in consideration of a large load being applied if the output power of the power conversion device is less than the reference output power.

If a fuel concentration in the mixing device 150 is less than a predetermined reference concentration, the controller 170 also increases an operation rate of the heat exchanger 140 to increase an amount of condensed unreacted fuel, or controls the pump 121 to increase the supply capacity of raw materials in the fuel storing unit 120. If the fuel concentration in the mixing device 150 exceeds the predetermined reference concentration, the controller 170 decrease an operation rate of the heat exchanger 140 to decrease an amount of condensed unreacted fuel, or controls the pump 121 to decrease the supply capacity of raw materials in the fuel storing unit 120. According to the above-mentioned configuration, electric generation efficiency of the fuel cell system may be maintained stably by maintaining a constant concentration of a hydrogen-containing fuel that is supplied from the mixing device 150 to the anode electrode of the stack 110.

As described above, the fuel cell system, which directly uses a fluid state of fuels, such as DMFC, etc., may be generally configured so that aqueous diluted fuels can be supplied to the stack 110, the diluted fuels being diluted at a suitable concentration to increase the electric generation efficiency and to prevent the loss of the fuel. To maintain a constant concentration of the diluted fuel is important to the performance of the fuel cell. For this purpose, a concentration of the diluted fuel is maintained constant using the controller 170 and a concentration sensor 100 for sensing a concentration of a diluted fuel. The controller 170 controls an operation of the pump 121 for injecting a high concentration fuel, or the heat exchanger 140 for condensing an effluent of the stack 110, depending on the sensing values of the concentration sensor 100.

However, the above-mentioned DMFC system does not secure a stable operation of the fuel cell system for an extended time since a concentration sensing characteristic of the concentration sensor changes with time. Accordingly, it is possible to secure a stable operation of the fuel cell system for an extended time by making up for the changes in the sensing characteristic of the concentration sensor by employing a separate concentration reference solution in the present invention.

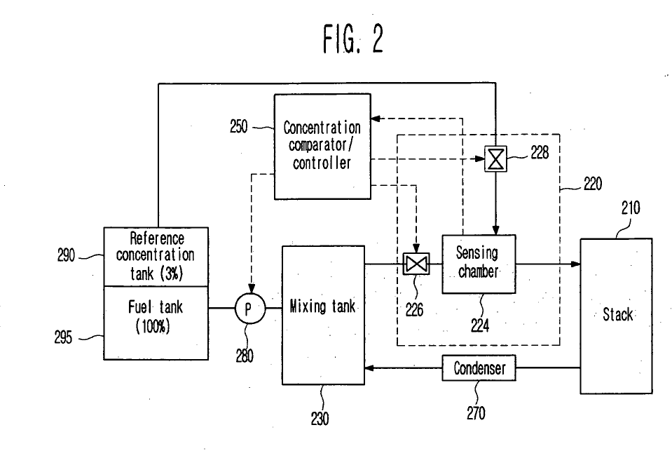

FIG. 2 is a block diagram of a DMFC system according to one exemplary embodiment of the present invention. As shown in FIG. 2, the fuel cell system includes a fuel cell stack 210 for generating electric power through an electrochemical reaction of diluted fuel and oxygen; a mixing tank 230 for mixing a raw fuel with water discharged from the fuel cell stack 210 to supply the resulting mixture to the fuel cell stack 210; a condenser 270 for condensing effluents of the fuel cell stack 210; a reference concentration tank 290 for storing a previously set optimum concentration of a reference solution for the fuel cell stack 210; a concentration sensing module 220 for measuring a concentration of one selected from the diluted fuel supplied from the mixing tank 230 to the fuel cell stack 210 and the reference solution stored in the reference concentration tank 290; and a concentration comparator/controller 250 for comparing the results obtained by measuring concentrations of the diluted fuel and the reference solution, and controlling influx quantity of fluids flowing in the mixing tank 230. The concentration sensing module 220 includes a sensing chamber 224, a first regulating unit 226 and a second regulating unit 228.

As shown in FIG. 2, the reference solution, sensed when the concentration sensing module 220 measures a reference solution of the reference solution, is supplied to the fuel cell stack 210, and consumed in the fuel cell stack 210, and therefore an amount of the stored reference solution in the reference concentration tank 290 is decreased with time. Accordingly, if the fuel tank 295 is realized as a cartridge that may be attachably/detachably exchanged in the fuel cell system, it is preferable to arrange the reference concentration tank 290 in the cartridge in which the fuel tank 295 is disposed.

The concentration comparator/controller 250 can function as the controller 150 of FIG. 1, and can be a hardware module and/or a software module including a digital processor.

The fuel cell system according to this exemplary embodiment may be operated in one mode of a normal mode for normal operation and a concentration correction mode for calculating a compensation value for deviation of the concentration sensor.

If the fuel cell system operates in the normal mode, the concentration comparator/controller 250 controls the condenser 270 and/or the fuel pump 280 in a feedback manner so that the concentration sensing module 220 can measure a concentration of a diluted fuel supplied from the mixing tank 230, and maintain a constant concentration sensing value of the diluted fuel.

If the fuel cell system operates in the concentration correction mode, the concentration comparator/controller 250 is operated so that the concentration sensing module 220 can measure a concentration of the reference solution supplied from the reference concentration tank 290 and calculate a concentration compensation value from the predetermined reference concentration value and a concentration value of the currently measured reference solution. An operation of the concentration comparator/controller 250 is described in detail, as follows.

A feed pump for supplying a diluted fuel in a mixing tank to a fuel cell stack is present in the previously discussed fuel cell system, but a component that functions as the feed pump also functions as a component in the concentration sensing module 220 in this exemplary embodiment, and therefore, the component is not shown in FIG. 2.

The condenser 270 functions to condense a cathode effluent of the fuel cell stack 210 discharged in a gaseous state into a fluid, and maybe a heat exchanging unit composed of a spiral pipe and a blast fan for cooling the spiral pipe with air, as shown in FIG. 1. An amount of the condensed cathode effluent is determined according to the cooling strength of the heat exchanging unit.

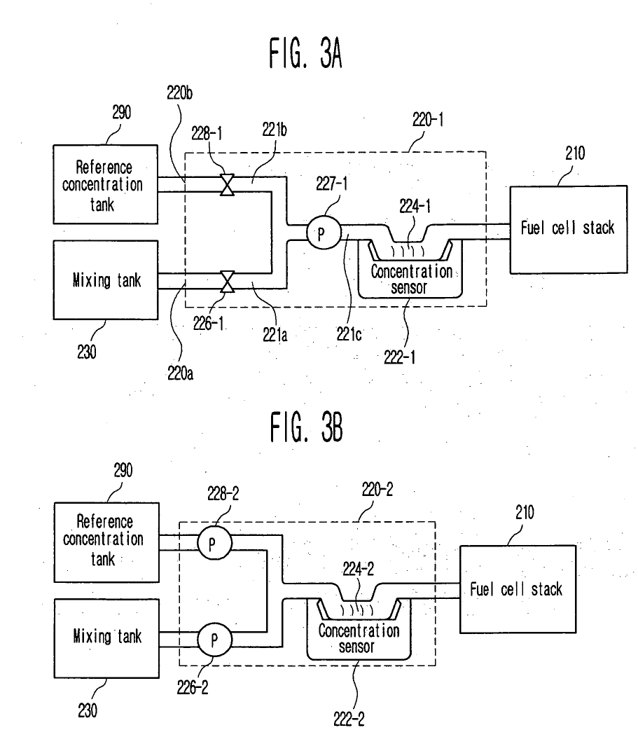

FIG. 3A and 3B are specific exemplary embodiments of the concentration sensing module 220 of FIG. 2. The concentration sensing module 220-1 of FIG. 3A is a concentration sensor that includes an ultrasonic sensor 222-1 composed of an ultrasonic transmitting unit and an ultrasonic receiving unit, and a space between the transmitting unit and the receiving unit of the ultrasonic sensor 222-1 functions as the sensing chamber 224-1.

Also, a reference solution inlet 220b coupled to the reference concentration tank 290, and two pipes 221a and 221b coupled to the mixing tank 230 are integrated into one pipe 221c. A feed pump 227-1 is installed in the integrated point. The diluted fuel in the mixing tank 230 or the reference solution in the reference concentration tank 290 move to the sensing chamber 224-1 through the pipe. That is, the fluid flows in an order of the point into which the two pipes 221a and 221b are integrated→the feed pump 227-1→the sensing chamber 224-2 ->the fuel cell stack 210.

The first regulating unit is a first valve 226-1 installed in the vicinity of the fuel inlet 220a to control the flow of the diluted fuel from the mixing tank 230, and the second regulating unit is a second valve 228-1 installed in the vicinity of the reference solution inlet 220b to control the flow of the reference solution from the reference concentration tank 290.

The sensing module 220-1 pumps all of the reference solution from the reference solution inlet 220b and the diluted fuel from the fuel inlet 220a to supply the pumped reference solution and diluted fuel to the sensing chamber 224-1, depending on the driving of the feed pump 227-1, or to supply one of the fluids, for example, the reference solution and the diluted fuel that can flow in through the opened valve, to the sensing chamber 224-1, depending on the operation of the concentration comparator/controller, since either the first valve 226-1 or the second valve 228-1 remains closed. Accordingly, the concentration sensor 222-1 outputs a value obtained by sensing either the reference solution or the diluted fuel over time.

The ultrasonic sensor 222-2 is applicable to the concentration sensing module 220-2 as shown in FIG. 3B, and a space between the transmitting unit and the receiving unit of the ultrasonic sensor functions as the sensing chamber 222-2.

Also, a first feed pump 226-2 for supplying a diluted fuel in the mixing tank 230 to the sensing chamber 224-2 is installed in the vicinity of the fuel inlet 220a, and a second feed pump 228 for supplying a reference solution in the reference concentration tank 290 to the sensing chamber 224-2 is installed in the vicinity of the reference solution inlet 220b. The first feed pump 226-2 functions as a first regulating unit, the second feed pump 228-2 functions as a second regulating unit, and the first feed pump 226-2 and the second feed pump 228-2 function as a valve by themselves, and therefore a separate valve may be omitted herein. The fluid pumped by the first feed pump 226-2 or the second feed pump 228-2 moves to the fuel cell stack 210 via the sensing chamber 224-2.

The sensing module 220-2 supplies one of the reference solution and the diluted fuel selected by the concentration comparator/controller to the sensing chamber 224-2 since one of the first feed pump 226-2 and the second feed pump 228-2 pumps a fuel according to the operation of the concentration comparator/controller. Accordingly, the concentration sensor 222-2 installed in the sensing chamber 224-2 outputs a value obtained by sensing one selected from the reference solution and the diluted fuel with time.

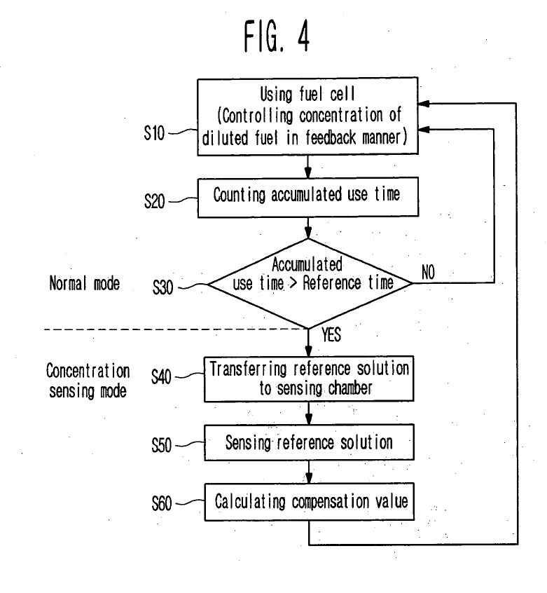

Hereinafter, an operation for concentration compensation of the concentration comparator/controller of FIG. 2 will be described in detail with reference to the accompanying FIG. 4 so as to realize the major features of the present invention.

In a normal operation mode, the concentration comparator/controller 250 controls the fuel cell system in a feedback manner using a measured concentration value so that the measured concentration value of the concentration sensing module 220 can be calculated as a preferable concentration of a diluted fuel (3% in this exemplary embodiment) (S10).

That is, if the measured concentration value exceeds 3%, the fuel cell system is controlled so that an amount of the condensed fuel in the condenser 270 can be increased to increase an amount of a stack effluent flowing in the mixing tank 230, whereas, if the measured concentration value is less than 3%, the fuel cell system is controlled so that an amount of the condensed fuel in the condenser 270 can be decreased, or the fuel pump 280 is operated to supply a high concentration fuel to the mixing tank 230, the mixing tank 230 having a thicker concentration than the diluted fuel.

Meanwhile, the concentration comparator/controller 250, which is operated in the above normal operation mode, determines whether it performs a concentration correction mode for correcting a concentration of the concentration sensor if an accumulated use time of the fuel cell system exceeds the predetermined reference time when the accumulated use time is counted in the initial use of the fuel cell system, or from a time point when the last concentration correction mode is completed (S30).

Determining that it operates the fuel cell system in the concentration correction mode, the concentration comparator/controller 250 controls a first regulating unit 226 constituting the concentration sensing module 220 to intercept the inflow of the diluted fuel, and controls a second regulating unit 228 to enable the inflow of the reference solution, and enable the inflow of the reference solution into the sensing chamber 224 (S40), thereby measuring a concentration of the reference solution (S50).

The concentration of the reference solution illustrated in this exemplary embodiment is 3%, and therefore, the measured concentration value of the concentration sensor should be 3% in the process of measuring the reference solution. However, if the measured concentration value of the concentration sensor is a value other than 3% due to the deterioration of the concentration sensor with the passage of time, a predetermined compensation value is calculated (S60). Then, a compensation value obtained by adding the compensation value to the measured concentration value of the concentration sensor is set to 3% which is a concentration value of the reference solution. Various mathematical functions for correction are applicable as the method of determining a predetermined compensation value, and an equation ‘compensation concentration value=3%—measured concentration value’ may the most simply be applicable herein. That is, a value that is obtained by subtracting the measured concentration value obtained by sensing the reference solution from 3% of a concentration value may be simply determined as a compensation value.

Hereinafter, the concentration comparator/controller 250 controls the first regulating unit 226 constituting the concentration sensing module 220 to enable the inflow of the diluted fuel, and controls the second regulating unit 228 to intercept the inflow of the reference solution, thereby driving the fuel cell system in a normal mode state.

As described above, the concentration comparator/controller 250 controls an operation of the fuel pump 280 or the condenser 270 in a feedback manner in the normal mode state, depending on the measured concentration value of the concentration sensor. The concentration comparator/controller 250 does not use the measured concentration value used as a standard of judgment of the feedback control as is, and therefore it is possible to solve the above problem regarding the deteriorated sensing characteristic of the concentration sensor using the compensation value calculated in the concentration correction mode.

The fuel cell system and/or the driving method thereof according to the exemplary embodiments of the present invention may be useful to exactly compensate for the deviation of the concentration sensor that is caused with the passage of time.

Although exemplary embodiments of the present invention have been shown and described, it would be appreciated by those skilled in the art that modifications may be made to these embodiments without departing from the principles and spirit of the present invention, the scope of which is defined by the following claims.

What is claimed is:

1. A fuel cell system comprising:
a fuel cell stack to generate electric power through an electrochemical reaction of hydrogen and oxygen;
a mixing tank to generate a diluted fuel by mixing a raw fuel with water discharged from the fuel cell stack;
a reference concentration tank to store a predetermined optimum concentration of a reference solution for the fuel cell stack; and
a concentration sensing module to measure a concentration of either the reference solution or the diluted fuel supplied from the mixing tank to the fuel cell stack.

2. The fuel cell system according to claim 1, wherein the concentration sensing module comprises:
a sensing chamber having a concentration sensor arranged within;
a reference solution inlet to enable inflow of the reference solution into the sensing chamber;
a fuel inlet to enable inflow of the diluted fuel into the sensing chamber;
a first regulating unit arranged within the fuel inlet; and
a second regulating unit arranged within the reference solution inlet.

3. The fuel cell system according to claim 1, wherein the concentration sensing module further comprises a concentration comparator/controller to compare the results obtained by measuring concentrations of the diluted fuel and the reference solution, and to control influx amounts of fluids flowing into the mixing tank.

4. The fuel cell system according to claim 1, further comprising a condenser to condense a cathode effluent of the fuel cell stack.

5. The fuel cell system according to claim 3, further comprising a fuel tank to store the raw fuel.

6. The fuel cell system according to claim 5, further comprising a fuel pump to transfer the raw fuel to the mixing tank, the concentration comparator/controller controlling pumping of the fuel pump.

7. The fuel cell system according to claim 2, wherein the first regulating unit comprises a first valve, the second regulating unit comprises a second valve, and the concentration sensing module further comprises a feed pump arranged at a junction of the reference solution inlet and the fuel inlet.

8. The fuel cell system according to claim 2, wherein the first regulating unit comprises a first feed pump to transfer the diluted fuel to the sensing chamber, and the second regulating unit comprises a second feed pump to transfer the reference solution to the sensing chamber.

9. The fuel cell system according to claim 3, wherein the concentration comparator/controller repeats the comparison of the results obtained by measuring concentrations of the diluted fuel and the reference solution at a predetermined time period after an initial operation of the fuel cell system, or at another predetermined time period after a recent comparison of the results obtained by measuring concentrations of the diluted fuel and the reference solution.

10. The fuel cell system according to claim 9, wherein the concentration comparator/controller calculates a compensation value to compensate for a deviation in sensing a concentration value according to the deterioration of the concentration sensing module.

11. The fuel cell system according to claim 5, wherein the fuel tank and the reference concentration tank are arranged within a cartridge attachably/detachably coupled to the fuel cell system.

12. A method of driving a fuel cell system, the method comprising:
(aa) using a concentration sensor to maintain a constant concentration of a diluted fuel supplied to a fuel cell stack:
(a) operating the fuel cell system in a normal mode while counting accumulated use time;
(b) operating the fuel cell system in a concentration sensing mode to calculate a compensation value of a concentration sensor in response to the counted accumulated use time being equal to a reference time; and
(c) applying the compensation value to a concentration sensing value of the concentration sensor.

13. The method of driving a fuel cell system according to claim 12, further comprising controlling the fuel cell system with feedback so that a value obtained by applying the compensation value to the concentration sensing value becomes a reference concentration.

14. The method of driving a fuel cell system according to claim 12, wherein, in operating the fuel cell system in a normal mode while counting accumulated use time and applying the compensation value to a concentration sensing value of the concentration sensor, the diluted fuel flows in a sensing chamber having the concentration sensor arranged within, and in operating the fuel cell system in a concentration sensing mode to calculate a compensation value of a concentration sensor in response to the counted accumulated use time being equal to a reference time, the solution having a reference concentration flows in the sensing chamber.

15. The method of driving a fuel cell system according to claim 14, wherein operating the fuel cell system in a concentration sensing mode to calculate a compensation value of a concentration sensor in response to the counted accumulated use time being equal to a reference time further comprises:
transferring the solution having a reference concentration to the sensing chamber;
sensing the reference solution with the concentration sensor to obtain concentration sensing values; and
calculating a compensation value from the difference between the concentration sensing value from the reference concentration value.
